(19) United States
(12) Patent Application Publication
(10) Pub. No.: US 2014/0180459 A1
(43) Pub. Date: Jun. 26, 2014

(54) HDMI Signal Processing System and Method

(71) Applicant: Much-ip Co., Ltd., Hsinchu County (TW)

(72) Inventors: Shoa-Hung LO, Hsinchu County (TW); Chia-Hong HSIEH, Hsinchu County (TW); Tung-Shu YANG, Hsinchu County (TW)

(73) Assignee: Much-ip Co., Ltd., Hsinchu County (TW)

(21) Appl. No.: 14/060,792

(22) Filed: Oct. 23, 2013

(30) Foreign Application Priority Data
Dec. 20, 2012 (TW) 101148657

(51) Int. Cl. G06F 3/16

(52) U.S. Cl. CPC G06F 3/16
USPC 700/94

(57) ABSTRACT

An HDMI signal processing system and a signal processing method are provided. The system includes a signal-receiving unit, an audio-extracting unit, and an audio-processing unit. An HDMI signal from an HDMI signal source is received at the signal-receiving unit. An audio signal is extracted from the received HDMI signal by the audio-extracting unit. The extracted audio signal is processed by the audio-processing unit.

The current application claims a foreign priority to the patent application of Taiwan No. 101148657 filed on Dec. 20, 2012.

### TECHNICAL FIELD

The present invention relates to HDMI signal processing; and more particularly, to a system and a method that separate the audio signal form HDMI signal and subsequently processing thereof.

### BACKGROUND ART

With the progress in technologies for processing multimedia contents, users have demanded for more powerful and more efficient processing schemes. In order to satisfy users' needs for high-quality presentation of audio and video contents, content providers have been increasingly developing newer and higher level specifications and regulations for multimedia signal processing and transmitting, so that the audiences can enjoy high-quality multimedia contents. To achieve such object, the pre-production and post-production capacities have to be enhanced; as well as the content transmission capacities or requirements. Otherwise, the multimedia contents that are produced and tailored in high-quality, hi-definition level could not be properly presented on the high-definition television or sound system.

According to the conventional specifications of multimedia signal transmission, video signals and audio signals are transmitted separately. For example, AV sockets, S sockets, optical fibers, and YPbPr sockets, all transmit video signals and audio signals through specific cables in separate ways. This increases complexity in arranging the cables, and especially for users having multiple devices, the twisted and bound cables always show themselves troublesome. More importantly, these old signal transmission specifications are unable to meet the requirements of high-quality contents nowadays.

As a result, a high-quality signal transmission specification called “High Definition Multimedia Interface”, i.e. HDMI, is developed to cope with such heavy loading transmissions. HDMI integrates the transmission of video and audio signals in a single cable, and it features high-quality multimedia signal transmission capabilities while minimizing the amount of cables and reducing the wiring complexity.

However, it is just because the HDMI integrates the transmission of video and audio in a single cable, when a user simply wants to listen to the music, or when a piece of multimedia information contains only audio with none video components, the user still has to play the content on a multimedia player that is capable of processing full audio/video HDMI signals, such as a TV set. In this case, the user needs to turn on the TV screen just to listen to the music, which gives a result of unnecessary power consumption.

On the other hand, even when the user wants to enjoy both audio and video contents on the TV set at the same time (for example watching a movie or a live concert), the audio component can only be presented through the TV set itself due to the single-cable signature of HDMI. One of the drawbacks of TV sets is that they usually lack the comparable audio processing power as professional sound systems have. This limits the overall audio/video experience of the user.

Therefore, it would be desirable to provide an HDMI signal processing mechanism to solve the above-mentioned problem.

### SUMMARY

It is therefore an object of the invention to provide an HDMI signal processing system and an HDMI signal processing method to separate the audio signal from the video signal in the HDMI signal.

According to one embodiment of the invention, the HDMI signal processing system includes a signal-receiving unit, an audio-extracting unit, and an audio-processing unit. The signal-receiving unit receives an HDMI signal from an HDMI signal source. The audio-extracting unit extracts an audio signal from the HDMI signal received by the signal-receiving unit. The audio-processing unit processes the audio signal extracted by the audio-extracting unit.

According to another embodiment of the invention, the HDMI signal processing system includes a signal-receiving unit, a signal-dividing circuit, an audio-extracting unit, an audio-processing unit, and an HDMI signal processing unit. The signal-receiving unit receives an HDMI signal from an HDMI signal source. The signal-dividing circuit divides the HDMI signal received by the signal-receiving unit into at least a first divisional HDMI signal and a second divisional HDMI signal. The audio-extracting unit extracts an audio signal from the first divisional HDMI signal. The audio-processing unit processes the audio signal extracted by the audio-extracting unit. The HDMI signal processing unit processes the second divisional HDMI signal.

According to another embodiment of the invention, the HDMI signal processing method includes the following steps. An HDMI signal from an HDMI signal source is received at a signal-receiving unit. An audio signal is extracted from the received HDMI signal by an audio-extracting unit. The extracted audio signal is processed by an audio-processing unit.

According to yet another embodiment of the invention, the HDMI signal processing method includes the following steps. An HDMI signal from an HDMI signal source is received at a signal-receiving unit. The received HDMI signal is divided into at least a first divisional HDMI signal and a second divisional HDMI signal by a signal-dividing circuit. An audio signal is extracted from the first divisional HDMI signal by an audio-extracting unit. The extracted audio signal is processed by an audio-processing unit. The second divisional HDMI signal is processed by an HDMI signal processing unit.

According to the above embodiments of the invention, the audio signal is extracted from the HDMI signal and therefore can be processed and manipulated independently. Furthermore, by dividing the HDMI signal, the audio signal can be acquired and the original HDMI signal can be preserved for outputting or following process. Therefore, the system and method of the embodiments have the merits of flexibility and convenience during the HDMI signal transmission.

### BRIEF DESCRIPTION OF DRAWINGS

FIG. 1 is a function block diagram of an HDMI signal processing system according to a first embodiment of the invention.

FIG. 2 is a flowchart of a method for processing an HDMI signal using the HDMI signal processing system according to the first embodiment of the invention.

FIG. 3 is a function block diagram of an HDMI signal processing system according to a second embodiment of the invention.

FIG. 4 is a flowchart of a method for processing an HDMI signal using the HDMI signal processing system according to the second embodiment of the invention.

### DETAIL DESCRIPTION

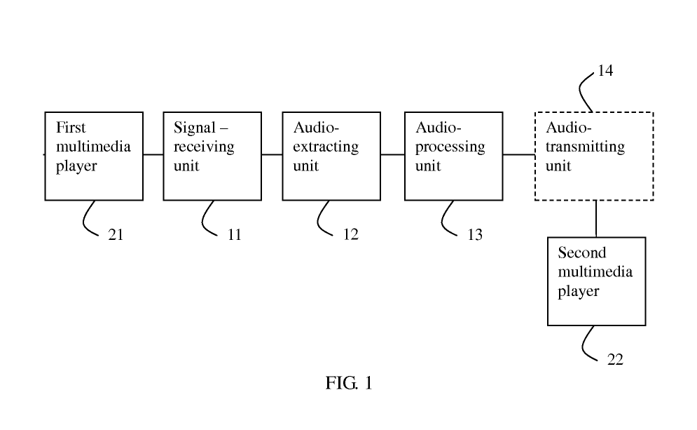

Please refer to FIG. 1, which is a function block diagram of a first embodiment of an HDMI signal processing system according to the present invention. In this embodiment, the HDMI signal processing system of the present invention includes a signal-receiving unit 11, an audio-extracting unit 12 and an audio-processing unit 13.

The disclosed HDMI signal processing system may be connected to a first multimedia player 21 and a second multimedia player 22. The first multimedia player 21 functions as an HDMI signal source and may be exemplified by a DVD player, a mobile phone or a tablet computer. The second multimedia player 22 plays audio signals and may be exemplified by an audio amplifier, an AV amplifier or an audio player.

The signal-receiving unit 11 receives an HDMI signal sent from the first multimedia player 21. In this embodiment, the signal-receiving unit 11 has an HDMI socket or an HDMI port that follows the HDMI specifications (not shown in the figure). The signal-receiving unit 11 also transmits the received HDMI signal to the audio-extracting unit 12.

The audio-extracting unit 12 receives the HDMI signal sent from the signal-receiving unit 11 and then extracts an audio signal from the HDMI signal. Subsequently, the audio-extracting unit 12 transmits the extracted audio signal to the audio-processing unit 13.

The audio-processing unit 13 receives the audio signal extracted by the audio-extracting unit 12 and then processes the extracted audio signal. Thereafter, the audio-processing unit 13 transmits the processed audio signal to the second multimedia player 22 for audio playback.

In one embodiment, the HDMI signal processing system may optionally include an audio-transmitting unit 14, which transmits the audio signal processed by the audio-processing unit 13 to the second multimedia player 22 through a wireless or wired transmission. Exemplarily, the suitable wireless transmission may include, but not limited to, radio frequency, Bluetooth and other technologies supportive to 2.4 GHz wireless transmission specifications.

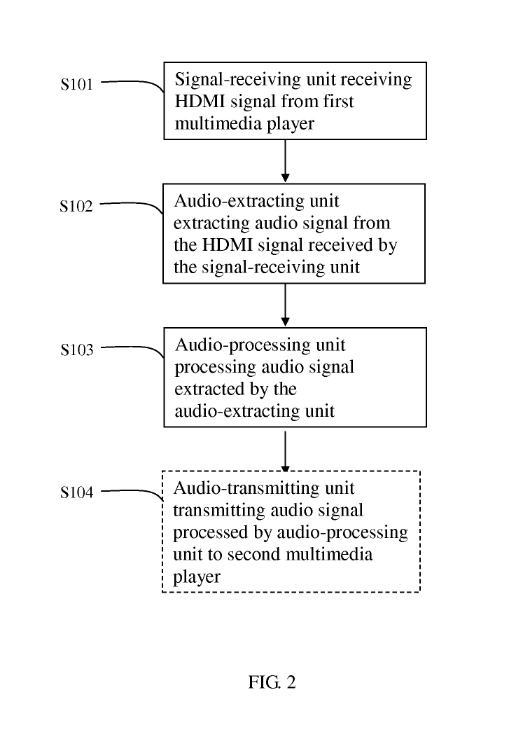

FIG. 2 is a flowchart of a method for processing an HDMI signal using the HDMI signal processing system of the above embodiment. As shown in step S101, the signal-receiving unit receives an HDMI signal from the first multimedia player and transmits the same to the audio-extracting unit. Then the method proceeds with a subsequent step S102.

In the step S102, the audio-extracting unit receives the HDMI signal transmitted by the signal-receiving unit and extracts from the HDMI signal an audio signal, which is then transmitted to the audio-processing unit. Then the method proceeds with a subsequent step S103.

In the step S103, the audio-processing unit receives and processes the audio signal extracted by the audio-extracting unit. The processed audio signal is then transmitted to the second multimedia player for audio playback.

The disclosed method for processing HDMI signals may further include a step S104, in which, the audio-transmitting unit transmits the audio signal processed by the audio-processing unit in a wireless or wired manner to the second multimedia player so that the second multimedia player can play the audio signal.

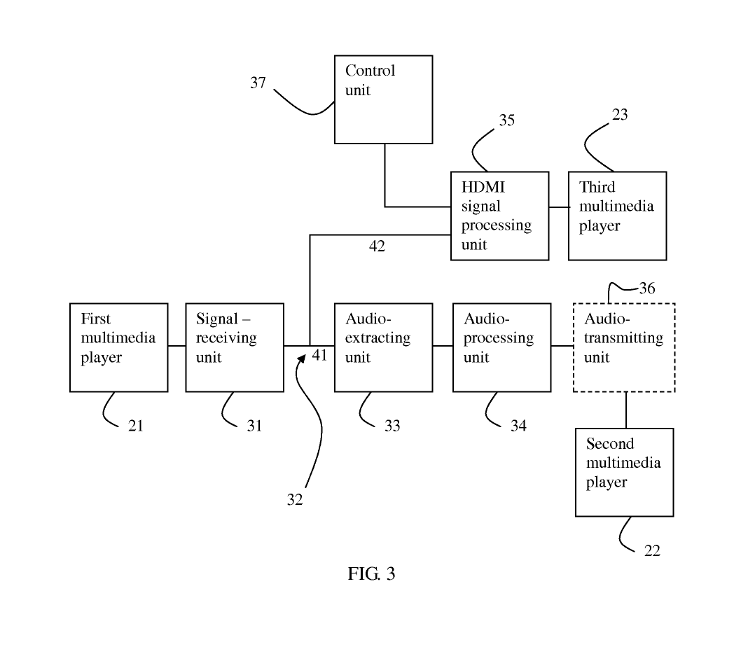

Please refer to FIG. 3, which is a function block diagram of a second embodiment of the HDMI signal processing system of the present invention. In the present embodiment, the disclosed HDMI signal processing system includes a signal-receiving unit 31, a signal-dividing circuit 32, an audio-extracting unit 33, an audio-processing unit 34 and an HDMI signal processing unit 35.

The present embodiment is similar to the first embodiment in allowing the HDMI signal processing system to connect with a first multimedia player 21 and a second multimedia player 22. The first multimedia player 21 functions as an HDMI signal source and the second multimedia player 22 plays audio signals. In this embodiment, however, a third multimedia player 23 is also included for receiving, processing and playing multimedia contents of the HDMI signal source. The third multimedia player 23 may be exemplified by a television set or a computer.

In this embodiment, the signal-receiving unit 31 of the HDMI signal processing system receives an HDMI signal from the first multimedia player 21 that functions as the HDMI signal source. The HDMI signal may be consisting of a video signal and an audio signal, such as a live concert record read out from a DVD player, or a piece of music downloaded from the internet by a tablet computer.

The signal-dividing circuit 32 divides the HDMI signal received by the signal-receiving unit 31 into at least a first divisional HDMI signal 41 and a second divisional HDMI signal 42. The first divisional HDMI signal 41 is transmitted to the audio-extracting unit 33 and the second divisional HDMI signal 42 is transmitted to the HDMI signal processing unit 35.

The audio-extracting unit 33 extracts an audio signal from the first divisional HDMI signal 41 and transmits the audio signal to an audio-processing unit 34.

The audio-processing unit 34 receives and processes the audio signal extracted by the audio-extracting unit 33. The processed audio signal can then be transmitted to the second multimedia player 22 for audio playback.

The HDMI signal processing unit 35 receives and process the second divisional HDMI signal 42 and transmits the processed HDMI signal to the third multimedia player 23 for content playback. In the present embodiment, the HDMI signal processing unit 35 not only performs general HDMI processing such as amplification, but also at least works to remove the audio signal from the second divisional HDMI signal 42 or extract signals other than the audio signal from the second divisional HDMI signal 42. With this function, a user can choose to only use the second multimedia player 22 to play the audio signal, such as music or human voice that is provided by the first multimedia player 21 and received by the disclosed system, without using the third multimedia player 23 (such as a TV set). Of course, a user may choose not to remove the audio signal from the HDMI signal to be transmitted to the third multimedia player 23 for HDMI playback.

In one embodiment, the disclosed HDMI signal processing system may also includes an audio-transmitting unit 36, which transmits the audio signal processed by the audio-processing unit 34 to the second multimedia player 22 in a wireless or wired manner.

In addition, the disclosed HDMI signal processing system may further include a control unit 37, which controls the HDMI signal processing unit 35 to perform at least one of the following functions: directly outputting the second divisional HDMI signal, removing the audio signal from the second divisional HDMI signal, extracting signals other than the audio signal from the second divisional HDMI signal, amplifying the second divisional HDMI signal, and blocking an output of the second divisional HDMI signal. Practically, the control unit 37 may send out its commands in a wired or wireless manner to operate the HDMI signal processing unit 35 to perform the foregoing and other HDMI signal processing functions.

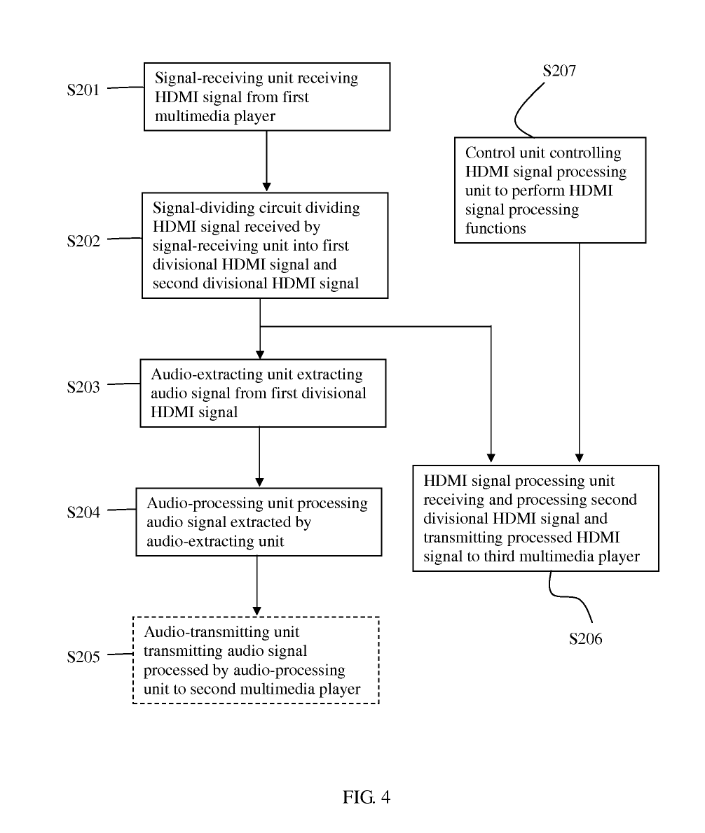

FIG. 4 is a flowchart of a method for processing an HDMI signal using the HDMI signal processing system of the above embodiment. As shown in step S201, the signal-receiving unit receives an HDMI signal from the first multimedia player. Then the method proceeds with subsequent step S202.

In step S202, through the signal-dividing circuit, the HDMI signal received by the signal-receiving unit is divided into at least the first divisional HDMI signal and the second divisional HDMI signal. Then the method proceeds with subsequent steps S203 and S206.

In step S203, the audio-extracting unit extracts an audio signal from the first divisional HDMI signal, and transmits the audio signal to the audio-processing unit. Then the method proceeds with subsequent step S204.

In step S204, the audio-processing unit receives and processes the audio signal extracted by the audio-extracting unit. The processed audio signal can then be transmitted to the second multimedia player for audio playback.

The disclosed HDMI signal processing method may further optionally comprise step S205, wherein the audio-transmitting unit transmits the audio signal processed by the audio-processing unit to the second multimedia player in a wireless or wired manner so that the audio signal can be played.

In step S206, the HDMI signal processing unit receives and processes the second divisional HDMI signal, and transmits the processed HDMI signal to the third multimedia player for HDMI playback.

The disclosed HDMI signal processing method may further optionally include step S207, wherein the control unit controls the HDMI signal processing unit to perform at least one of the following functions: directly outputting the second divisional HDMI signal, removing the audio signal from the second divisional HDMI signal, extracting signals other than the audio signal from the second divisional HDMI signal, amplifying the second divisional HDMI signal, and blocking an output of the second divisional HDMI signal.

In view of prior art, the HDMI signal processing system and method of the present invention extract the audio signal from the HDMI signal and process the audio signal separately, and moreover, the system and the method of the present invention divide the HDMI signal. As a result, in one hand, the audio signal can be extracted and processed regardless the video signal, and in the other hand, the HDMI signal can be kept intact for later processes such as extracting the audio signal from the HDMI signal, outputting the intact HDMI signal, removing the audio signal from the HDMI signal, extracting signals other than the audio signal from the HDMI signal, amplifying the HDMI signal, blocking the output of the divisional HDMI signal or other desired HDMI signal processing operations. Thus, users can enjoy more flexibility and convenience during signal transmission of the HDMI specifications.

What is claimed is:

1. An HDMI signal processing system, comprising:
a signal-receiving unit, for receiving an HDMI signal from an HDMI signal source;
an audio-extracting unit, for extracting an audio signal from the HDMI signal received by the signal-receiving unit; and
an audio-processing unit, for processing the audio signal extracted by the audio-extracting unit.

2. The HDMI signal processing system of claim 1, further comprising an audio-transmitting unit, for transmitting the audio signal processed by the audio-processing unit to an external audio player.

3. An HDMI signal processing system, comprising:
a signal-receiving unit, for receiving an HDMI signal from an HDMI signal source;
a signal-dividing circuit, for dividing the HDMI signal received by the signal-receiving unit into at least a first divisional HDMI signal and a second divisional HDMI signal;
an audio-extracting unit, for extracting an audio signal from the first divisional HDMI signal;
an audio-processing unit, for processing the audio signal extracted by the audio-extracting unit; and
an HDMI signal processing unit, for processing the second divisional HDMI signal.

4. The HDMI signal processing system of claim 3, further comprising an audio-transmitting unit, for transmitting the audio signal processed by the audio-processing unit to an external audio player.

5. The HDMI signal processing system of claim 3, further comprising a control unit, for controlling the HDMI signal processing unit to perform at least one of the functions comprising direct outputting the second divisional HDMI signal, removing an audio signal carried in the second divisional HDMI signal, extracting signals other than the audio signal from the second divisional HDMI signal, amplifying the second divisional HDMI signal, and blocking an output of the second divisional HDMI signal.

6. The HDMI signal processing system of claim 3, further comprising an HDMI signal transmitting terminal for transmitting the signal processed by the HDMI signal processing unit to an external multimedia player.

7. An HDMI signal processing method, comprising the following steps:
receiving, at a signal-receiving unit, an HDMI signal from an HDMI signal source;
extracting, by using an audio-extracting unit, an audio signal from the HDMI signal received by the signal-receiving unit; and
processing, by using an audio-processing unit, the extracted audio signal.

8. The HDMI signal processing method of claim 7, further comprising the following step:
transmitting the processed audio signal to an external audio player by using an audio-transmitting unit.

9. An HDMI signal processing method, comprising:
receiving, at a signal-receiving unit, an HDMI signal from an HDMI signal source;
dividing, by using a signal-dividing circuit, the received HDMI signal into at least a first divisional HDMI signal and a second divisional HDMI signal;
extracting, by using an audio-extracting unit, an audio signal from the first divisional HDMI signal;
processing, by using an audio-processing unit, the extracted audio signal; and
processing, by using an HDMI signal processing unit, the second divisional HDMI signal.

10. The HDMI signal processing method of claim 9, further comprising the following step:
transmitting, by using an audio-transmitting unit, the processed audio signal to an external audio player.

11. The HDMI signal processing method of claim 9, further comprising the following step:
controlling the HDMI signal processing unit by using a control unit so as to perform at least one of the steps comprising direct outputting the second divisional HDMI signal, removing the audio signal carried in the second divisional HDMI signal, extracting signals other than the audio signal from the second divisional HDMI signal, amplifying the second divisional HDMI signal, and blocking an output of the second divisional HDMI signal.
